(19) United States
(12) Patent Application Publication
(10) Pub. No.: US 2017/0064493 A1
(43) Pub. Date: Mar. 2, 2017

(54) ULTRAVIOLET DETECTION SYSTEM AND METHOD

(71) Applicant: Shenzhen Hali-Power Industrial Co., Ltd., Shenzhen (CN)

(72) Inventor: Xiaomin ZHU, Shenzhen (CN)

(21) Appl. No.: 15/013,943

(22) Filed: Feb. 2, 2016

(30) Foreign Application Priority Data
Sep. 2, 2015 (CN) 201510556391.X

(51) Int. Cl. H04W 4/00; G01J 1/42

(52) U.S. Cl. CPC H04W 4/008; G01J 1/429

(57) ABSTRACT

An ultraviolet detection system and method comprises a Bluetooth MCU control unit, a Bluetooth antenna impedance matching unit and an ultraviolet detection unit. A sensor is a silicon product, which is formed by SOI technology, and the sensor can test the current UVI accurately and quickly, such that the ultraviolet detection system can provide accurate advice to customers to avoid being sunburned. The Bluetooth MCU is a low power consumption Bluetooth chip.

### BACKGROUND

1. Technical Field

The present disclosure generally relates to a detection region, and especially relates to an ultraviolet detection region.

2. Description of Related Art

Users need to visually learn more about current ultraviolet (UV) ray conditions, such that users can adopt rigorous measures to timely defend against UV rays. Users can adopt rigorously measure to defend against UV rays more intelligently.

Therefore, a need exists in the industry to overcome the described problems.

### SUMMARY

The disclosure is to offer an ultraviolet detection system and a method of detecting the ultraviolet.

An ultraviolet detection system comprises a Bluetooth MCU control unit, a Bluetooth antenna impedance matching unit having a power key, and an ultraviolet detection unit having an ultraviolet sensor, the Bluetooth antenna impedance matching unit includes an IC matching circuit and a terminal matching circuit, the Bluetooth MCU control unit is used to do AD testing, LED controlling, and antenna impedance matching; wherein the ultraviolet detection unit is exposed to light, an ultraviolet photoelectric diode is composed of a top silicon and located inside the ultraviolet detection unit, produces a current corresponding to radiation intensity of ultraviolet radiation of the light, wherein current of an operational amplifier of the ultraviolet detection unit forms an output voltage corresponding to the current, the output voltage is transmitted to the Bluetooth MCU control unit, and the Bluetooth MCU control unit samples electrical signals, the Bluetooth MCU control unit is used to do AD sampling and testing, receiving and sending data signal, logic controlling, the Bluetooth antenna impedance matching unit is matched with the Bluetooth MCU control unit, and partly matched with an on board antenna of the Bluetooth antenna.

Preferably, the ultraviolet detection unit is a silicon product formed by an SOI technology, the SOI technology is a buried oxide layer between a top silicon layer and a substrate

Preferably, the ultraviolet detection unit converts intensities of the ultraviolet into an analog voltage, and outputs the analog voltage, the output analog voltage is converted to an ultraviolet intensity value according to a relationship among the inputting voltage, ADC voltage and UVI, and the ultraviolet intensity value is shown on an application of the terminal device.

Preferably, a fifth terminal and an eighth terminal of the Bluetooth control unit are connected with the ultraviolet detection unit, and used to test and integrate the ultraviolet intensity value.

Preferably, the ultraviolet detection unit further includes a chip, an OUT terminal of the chip is connected with a fifth terminal of the Bluetooth MCU, an EN terminal of the chip is connected with the eighth terminal of the Bluetooth MCU control unit, a TR terminal of the chip is connected with a seventeenth capacitor and the grounded, a GND terminal of the chip is grounded, a VDD terminal of the chip is connected with a power VCC, a fifteenth capacitor is connected between the GND terminal of the chip and the VDD terminal of the chip.

Preferably, a seventh terminal of the Bluetooth MCU unit is connected with a resistor and a light emitting diode, the seventh terminal of the Bluetooth MCU unit controls the light emitting diode.

Preferably, a thirty first terminal of the Bluetooth MCU control unit and a thirty second terminal of the Bluetooth MCU control unit are both connected with the Bluetooth antenna impedance matching unit.

Preferably, a circuit of the Bluetooth antenna impedance matching unit includes a first coil, a second coil, a third coil, a fourth coil, a third capacitor, a fourth capacitor, a fifth capacitor, a sixth capacitor, a fourteenth capacitor, a sixteenth capacitor, and an antenna; the antenna, the sixteenth capacitor, the fourteenth capacitor, the fifth capacitor, the first coil, the second coil, the third capacitor are cascaded with each other in sequence, and then grounded, a lead between the first coil and the fifth capacitor is connected with the thirty second terminal of the Bluetooth MCU control unit, another lead between the first coil and the second coil is connected with the thirty first terminal of the Bluetooth MCU control unit, a lead between the second coil and the third capacitor is connected with a thirtieth terminal of the Bluetooth MCU control unit, the fourth capacitor is connected between the fifth capacitor and the fourteenth capacitor, and then grounded, the fourth capacitor is located between the fifth capacitor and the fourteenth capacitor, the fourteenth capacitor and the sixteenth capacitor are connected with the sixth capacitor and the second coil in parallel, and then grounded, the fourth coil is connected with the sixteenth capacitor and the antenna, and then grounded, the fourth coil is located between the sixteenth capacitor and the antenna.

Preferably, the Bluetooth MCU control unit is a chip which has forty eight foot, a first terminal of the chip is connected with a power VCC, and the first terminal of the chip is grounded through a twelfth capacitor; a ninth terminal of the chip is connected with a switch; a twelfth terminal of the chip is connected with the power VCC, and the twelfth terminal of the chip is grounded through an eleven capacitor; a thirteen terminal of the chip is grounded; a twenty fourth terminal is grounded by a first resistor, a twenty third terminal is connected with a D point, the twenty fourth terminal is connected with a C point, a G point is grounded, and the D point, the C point and the G point are burning points; a twenty ninth terminal is grounded through a tenth capacitor, a thirty third terminal and a thirty fourth terminal are both grounded, a thirty fifth terminal and a thirty sixth terminal are both connected with the power VCC, the thirty fifth terminal and the thirty sixth terminal are grounded through a ninth capacitor, a thirty seventh terminal is grounded through a first capacitor, a thirty eighth terminal is grounded through the second capacitor, a crystal oscillator is located between the thirty seventh terminal and the thirty eighth terminal, and the crystal oscillator is connected with the thirty eighth terminal and the thirty eighth terminal, a thirty ninth terminal is grounded through a eighth capacitor.

A method of detecting ultraviolet based on an ultraviolet detection system comprising a Bluetooth MCU control unit and a sensor, the method comprising: an application installed in a terminal device having a terminal Bluetooth; the Bluetooth MCU control unit transmitting a broadcast; the terminal device recognizing the broadcast after the terminal Bluetooth matching with the Bluetooth MCU control unit; the ultraviolet detection system exposed within a light together with the sensor facing the light; the sensor converting intensities of ultraviolet light into electrical signals; the Bluetooth MCU control unit receiving the electrical signals transmitted by the sensor; and the Bluetooth MCU control unit calculating an ultraviolet intensity value in light of the electrical signals and transmitting the ultraviolet intensity value to the terminal device to display to the user.

Preferably, the ultraviolet detection system comprises a Bluetooth antenna impedance matching unit and an ultraviolet detection unit, the Bluetooth antenna impedance matching unit is matched with the Bluetooth MCU control unit, and partly matched with an on board antenna of the Bluetooth antenna.

Preferably, the ultraviolet detection unit is defined as a silicon product formed by an SOI technology, the SOI technology refers to a buried oxide layer between the top silicon and a substrate.

Preferably, the ultraviolet detection unit converts intensities of the ultraviolet according to the SOI technology, and transforms the ultraviolet intensity into an analog voltage, and outputs the analog voltage, the output analog voltage is converted to an ultraviolet intensity value according to a relationship among the inputting voltage.

Preferably, a fifth terminal and an eighth terminal of the Bluetooth control unit are connected with the ultraviolet detection unit, and used to test and integrate the ultraviolet intensity value.

Preferably, the ultraviolet detection unit further includes a chip, an OUT terminal of the chip is connected with a fifth terminal of the Bluetooth MCU, an EN terminal of the chip is connected with the eighth terminal of the Bluetooth MCU control unit, a TR terminal of the chip is connected with a seventeenth capacitor and the grounded, a GND terminal of the chip is grounded, a VDD terminal of the chip is connected with a power VCC, a fifteenth capacitor is connected between the GND terminal of the chip and the VDD terminal of the chip.

Preferably, a seventh terminal of the Bluetooth MCU unit is connected with a resistor and a light emitting diode, the seventh terminal of the Bluetooth MCU unit controls the light emitting diode.

Preferably, a thirty first terminal of the Bluetooth MCU control unit and a thirty second terminal of the Bluetooth MCU control unit are both connected with the Bluetooth antenna impedance matching unit.

Preferably, a circuit of the Bluetooth antenna impedance matching unit includes a first coil, a second coil, a third coil, a fourth coil, a third capacitor, a fourth capacitor, a fifth capacitor, a sixth capacitor, a fourteenth capacitor, a sixteenth capacitor, and an antenna; the antenna, the sixteenth capacitor, the fourteenth capacitor, the fifth capacitor, the first coil, the second coil, the third capacitor are cascaded with each other in sequence, and then grounded, a lead between the first coil and the fifth capacitor is connected with the thirty second terminal of the Bluetooth MCU control unit, another lead between the first coil and the second coil is connected with the thirty first terminal of the Bluetooth MCU control unit, a lead between the second coil and the third capacitor is connected with a thirtieth terminal of the Bluetooth MCU control unit, the fourth capacitor is connected between the fifth capacitor and the fourteenth capacitor, and then grounded, the fourth capacitor is located between the fifth capacitor and the fourteenth capacitor, the fourteenth capacitor and the sixteenth capacitor are connected with the sixth capacitor and the second coil in parallel, and then grounded, the fourth coil is connected with the sixteenth capacitor and the antenna, and then grounded, the fourth coil is located between the sixteenth capacitor and the antenna.

Preferably, the Bluetooth MCU control unit is a chip which has forty eight foot, a first terminal of the chip is connected with a power VCC, and the first terminal of the chip is grounded through a twelfth capacitor; a ninth terminal of the chip is connected with a switch; a twelfth terminal of the chip is connected with the power VCC, and the twelfth terminal of the chip is grounded through an eleven capacitor; a thirteen terminal of the chip is grounded; a twenty fourth terminal is grounded by a first resistor, a twenty third terminal is connected with a D point, the twenty fourth terminal is connected with a C point, a G point is grounded, and the D point, the C point and the G point are burning points; a twenty ninth terminal is grounded through a tenth capacitor, a thirty third terminal and a thirty fourth terminal are both grounded, a thirty fifth terminal and a thirty sixth terminal are both connected with the power VCC, the thirty fifth terminal and the thirty sixth terminal are grounded through a ninth capacitor, a thirty seventh terminal is grounded through a first capacitor, a thirty eighth terminal is grounded through the second capacitor.

Preferably, a crystal oscillator is located between the thirty seventh terminal and the thirty eighth terminal, and the crystal oscillator is connected with the thirty eighth terminal and the thirty eighth terminal, a thirty ninth terminal is grounded through a eighth capacitor.

Compared to the traditional ultraviolet detection system, the sensor of the present invention is a silicon product which is made by the SOI technology, and the sensor can test the current UVI accurately and quickly, such that the ultraviolet detection system can provide accurate advice to our customers to avoid the customers being sunburned. The Bluetooth MCU is a low power consumption Bluetooth chip, and can working long hours for testing the ultraviolet index.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is a schematic diagram of an ultraviolet detection system.

FIG. 2 is an isometric view of a circuit structure of the ultraviolet detection system.

FIG. 3 is an isometric view of a Bluetooth MCU control unit 1 of the ultraviolet detection system.

FIG. 4 is an isometric view of a Bluetooth antenna impedance matching unit 2 of the ultraviolet detection system.

FIG. 5 is an isometric view of an ultraviolet detection unit 3 of the ultraviolet detection system.

FIG. 6 is a flow chart of a method for detecting ultraviolet based on the ultraviolet detection system.

### DETAILED DESCRIPTION

The disclosure is illustrated by way of example and not by way of limitation in the figures of the accompanying drawings, in which like reference numerals indicate similar elements. It should be noted that references to “an” or “one” embodiment in this disclosure are not necessarily to the same embodiment, and such references can mean “at least one” embodiment.

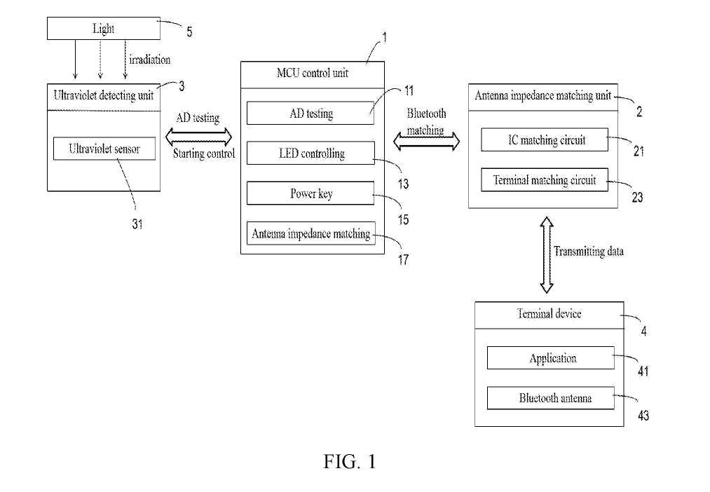

With reference to FIG. 1, FIG. 1 is a schematic diagram of an ultraviolet detection system, the ultraviolet detection system includes a Bluetooth MCU control unit 1 (microcontroller Unit, MCU), a Bluetooth antenna impedance matching unit 2, an ultraviolet detection unit 3 having an ultraviolet sensor 31. The Bluetooth antenna impedance matching unit 2 includes an IC matching circuit 21 and a terminal matching circuit 23. The Bluetooth MCU control unit 1 has a power key 15, and has the following functions, such as: AD testing 11, LED controlling 13 (light emitting diode, LED), antenna impedance matching 17.

The ultraviolet detection system can be connected with a terminal device 4 to send a tested ultraviolet radiation intensity data to the terminal device 4 through a Bluetooth technology, the terminal device 4 can be a mobile phone or a tablet personal computer. The ultraviolet detection system is mainly used to test ultraviolet intensity in light 5 having a wavelength range of about 280-400 nm, that is, the ultraviolet detection system can be used to test UV-A and UV-B intensity. A supported application 41 can be installed in the terminal device 4, the supported application 41 can be a MiLi SkinMate application, when the power key 15 is pressed, the Bluetooth MCU can transmit a broadcast, at this time user can select to boot a Bluetooth antenna 43 of the terminal device 4, and then select corresponding service set identifier (SSID) of the broadcast on the application interface, after the Bluetooth antenna 43 is matched and connected with the ultraviolet detection system, the terminal device 4 recognizes the broadcast, and the tested ultraviolet intensity value is calculated by a Bluetooth MCU algorithm and then sent to the application of the terminal device 4, and user can observe the ultraviolet intensity value visually.

The sensor 31 can convert the intensities of the ultraviolet light according to an SOI technology and transform the ultraviolet intensity into an analog voltage, and output the analog voltage, the output analog voltage is converted to an ultraviolet intensity value according to a relationship among the inputting voltage, ADC voltage and UVI (Ultra Violet Index), such that the ultraviolet intensity value can be shown on the application of the terminal device 4. The relationship among the inputting voltage, ADC voltage and UVI (Ultra Violet Index) can be: UVI=12.5*Vout, Vout=0.12V @1 mw/m².

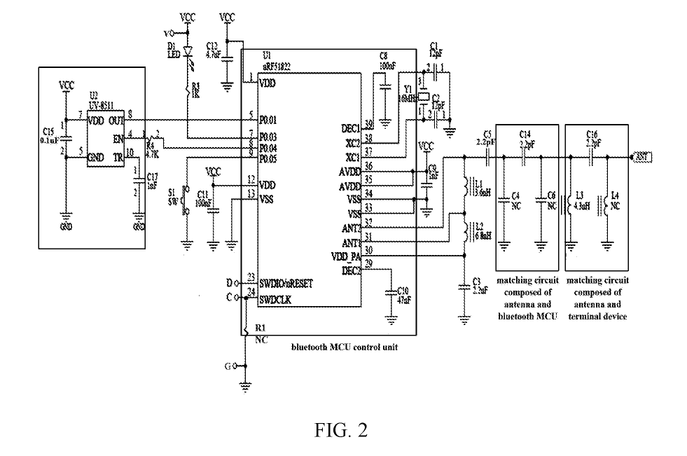

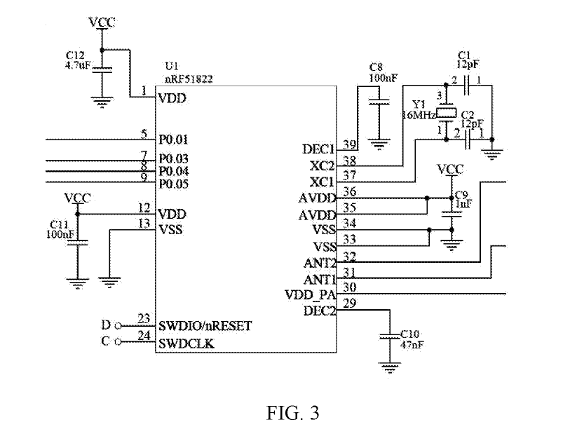

Referring to FIGS. 2-3, FIG. 2 is an isometric view of a circuit structure of the ultraviolet detection system, FIG. 3 is an isometric view of the Bluetooth MCU control unit of the ultraviolet detection system. The Bluetooth MCU control unit 1 is mainly responsible for AD sampling testing, sending and receiving the data signal, logic control. A fifth terminal and an eighth terminal are connected with the ultraviolet detection unit 3, and can be used to test and integrate the ultraviolet intensity value. A seventh terminal is connected with a resistor R3 and a light emitting diode to control a state of the light emitting diode. A thirty first terminal and a thirty second terminal are connected with the Bluetooth antenna impedance matching unit 2.

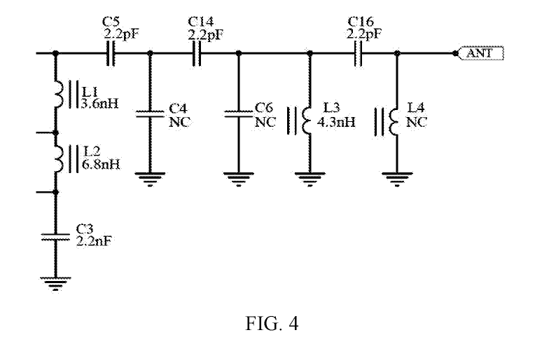

Referring to FIG. 4, FIG. 4 is an isometric view of the Bluetooth antenna impedance matching unit, the Bluetooth antenna impedance matching unit 2 is mainly responsible for matching with the Bluetooth MCU 1, and partly matching with an on board antenna of the Bluetooth antenna 41, such that the ultraviolet detection system can transmit the data to the terminal device 4 reliably and remotely.

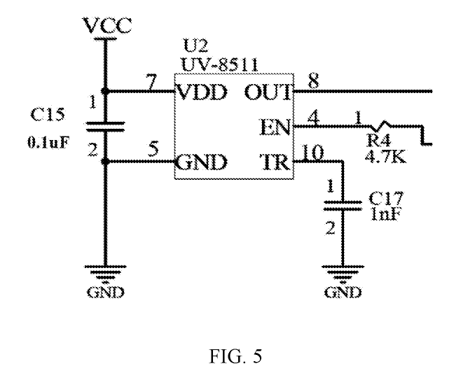

Referring to FIG. 5, FIG. 5 is an isometric view of the ultraviolet detection unit, the ultraviolet detection unit 3 adopts the sensor 31 which can be a UV sensor, the UV sensor can be a silicon product which is formed by the SOI technology. The SOI technology includes a top silicon, a substrate, and a buried oxide (BOX) layer which is located between the top silicon and the substrate. The SOI technology has important advantages over the bulk silicon, such as: the SOI technology can realize the dielectric isolation of components which are located inside the integrated circuit, and eliminate the parasitic latch up effect of bulk silicon CMOS circuit completely; the integrated circuit having the buried oxide layer further has the following advantages, such as: little parasitic capacitance, high integration density, high speed, simple prepared, short-channel effects, especially suitable for low voltage and low power circuit, and so on. The advantages of SOI technology can ensure that the ultraviolet detection system of the present invention test the current UVI accurately and quickly, such that the ultraviolet detection system can provide accurate advice to our customers to avoid the customers being sunburned. When the sensor 31 is exposed in light 5, the UV photodiode composed of the top silicone is irradiated by the ultraviolet having a certain radiation intensity to generate small current corresponding to the radiation intensity of the ultraviolet, the current is transformed to a corresponding output voltage by the OP amplifier located inside the sensor 31, the MCU control unit 1 samples the output voltage to get a plurality of samples.

The ultraviolet detection system includes the Bluetooth MCU control unit 1, the Bluetooth antenna impedance matching unit 2 and the ultraviolet detection unit 3; when the ultraviolet irradiates on the ultraviolet detection unit 3, a UV photoelectric diode located in the ultraviolet detection unit 3 is exposed in the ultraviolet radiation with a certain UV radiation strength to produce current corresponding to the radiation strength of the UV radiation, the UV photoelectric diode is formed by the top silicon, the current can pass through an operational amplifier located inside the ultraviolet detection unit 3 to form output voltage corresponding to the current, the output voltage is transmitted to the Bluetooth MCU control unit 1, the Bluetooth MCU control unit 1 samples, the Bluetooth MCU control unit 1 is mainly responsible for AD sampling and testing, receiving and sending data signal, controlling of logic; the Bluetooth antenna impedance matching unit 2 is mainly responsible for matching with the Bluetooth MCU control unit 1, and partly matching with a on board antenna, such that the ultraviolet detection system can transmit the data to the terminal device 4 reliably and remotely.

The ultraviolet detection unit 3 can be the silicon product which is made by the SOI technology, the SOI technology refers to locating the buried oxide layer between the top silicon and the substrate.

The ultraviolet detection unit 3 converts the ultraviolet intensity according to the SOI technology, and transforms the ultraviolet intensity into the analog voltage, and output the analog voltage, the analog voltage is converted to the ultraviolet intensity value according to the relationship among the inputting voltage, ADC voltage and UVI (Ultra Violet Index), such that the ultraviolet intensity value can be shown on the application of the terminal device 4.

The fifth terminal and the eighth terminal of the Bluetooth MCU control unit 1 can be both connected with the ultraviolet detection unit 3, and test and integrate the the ultraviolet intensity value.

The ultraviolet detection unit 3 includes a chip U2, an OUT terminal of the chip U2 is connected with the fifth terminal of the Bluetooth MCU control unit 1, an EN terminal of the chip U2 is connected with the eighth terminal of the Bluetooth MCU control unit 1, a TR terminal of the chip U2 is connected with a seventeenth capacitor C17 and the grounded, a GND terminal of the chip U2 is grounded, a VDD terminal of the chip U2 is connected with a power 7 which is presented as VCC, a fifteenth capacitor C15 is connected between the GND terminal of the chip U2 and the VDD terminal of the chip U2.

A seventh terminal of the Bluetooth MCU control unit 1 is connected with a resistor R3 and a light emitting diode (LED), the seventh terminal of the Bluetooth MCU control unit 1 controls a state of the light emitting diode.

A thirty first terminal of the Bluetooth MCU control unit 1 and a thirty second terminal of the Bluetooth MCU control unit 1 are both connected with the Bluetooth antenna impedance matching unit 2.

A circuit of the Bluetooth antenna impedance matching unit 2 includes a first coil L1, a second coil L2, a third coil L3, a fourth coil L4, a third capacitor C3, a fourth capacitor C4, a fifth capacitor C5, a sixth capacitor C6, a fourteenth capacitor C14, a sixteenth capacitor C16, and an antenna; the antenna, the sixteenth capacitor C16, the fourteenth capacitor C14, the fifth capacitor C5, the first coil L1, the second coil L2, the third capacitor C3 are cascaded with each other in sequence, and then grounded, a lead between the first coil L1 and the fifth capacitor C5 is connected with the thirty second terminal of the Bluetooth MCU control unit 1, another lead between the first coil L1 and the second coil L2 is connected with the thirty first terminal of the Bluetooth MCU control unit 1, a lead between the second coil L2 and the third capacitor C3 is connected with a thirtieth terminal of the Bluetooth MCU control unit 1, the fourth capacitor C4 is connected between the fifth capacitor C5 and the fourteenth capacitor C14, and then grounded, the fourth capacitor C4 is located between the fifth capacitor C5 and the fourteenth capacitor C14, the fourteenth capacitor C14 and the sixteenth capacitor C16 are connected with the sixth capacitor C6 and the second coil L3 in parallel, and then grounded, the fourth coil L4 is connected with the sixteenth capacitor C16 and the antenna, and then grounded, the fourth coil L4 is located between the sixteenth capacitor C16 and the antenna.

In at least one exemplary embodiment, the Bluetooth MCU control unit 1 can be a chip which has forty eight foot, a first terminal of the chip is connected with a power VCC 7 (Volt Current Condenser, VCC), and the first terminal of the chip is grounded through a twelfth capacitor C12; a ninth terminal of the chip is connected with a switch which is presented as SW; a twelfth terminal of the chip is connected with the power VCC 7, and the twelfth terminal of the chip is grounded through an eleven capacitor C11; a thirteen terminal of the chip is grounded; a twenty fourth terminal is grounded by a first resistor R1, a twenty third terminal is connected with a D point, the twenty fourth terminal is connected with a C point, a G point is grounded, and the D point, the C point and the G point are burning points; a twenty ninth terminal is grounded through a tenth capacitor C10, a thirty third terminal and a thirty fourth terminal are both grounded, a thirty fifth terminal and a thirty sixth terminal are both connected with the power 7, the thirty fifth terminal and the thirty sixth terminal are grounded through a ninth capacitor C9, a thirty seventh terminal is grounded through a first capacitor C1, a thirty eighth terminal is grounded through the second capacitor C2, a crystal oscillator Y1 is located between the thirty seventh terminal and the thirty eighth terminal, and the crystal oscillator Y1 is connected with the thirty eighth terminal and the thirty eighth terminal, a thirty ninth terminal is grounded through a eighth capacitor C8.

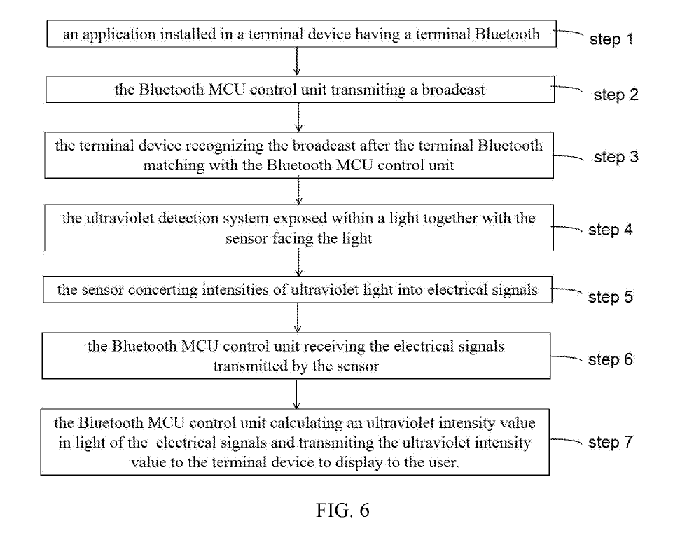

Referring to FIG. 6, FIG. 6 is a flow chart of a method for detecting ultraviolet based on the ultraviolet detection system. The method of detecting ultraviolet based on the ultraviolet detection system, the method comprising: step 1: an application 41 installed in a terminal device 4 having a terminal Bluetooth antenna 43; step 2: a power key 15 of the ultraviolet detection system is pressed, such that the Bluetooth MCU control unit 1 transmitting a broadcast; step 3: the terminal device 4 recognizing the broadcast after the terminal Bluetooth antenna 43 matching with the Bluetooth MCU control unit 1; step 4: the ultraviolet detection system exposed within a light 5 together with the sensor 31 facing the light 5; the sensor 31 converting intensities of ultraviolet light into electrical signals; the Bluetooth MCU control unit 1 receiving the electrical signals transmitted by the sensor 31; and the Bluetooth MCU control unit 1 calculating an ultraviolet intensity value in light of the electrical signals and transmitting the ultraviolet intensity value to the terminal device 4 to display to the user.

Although the features and elements of the present disclosure are described as embodiments in particular combinations, each feature or element can be used alone or in other various combinations within the principles of the present disclosure to the full extent indicated by the broad general meaning of the terms in which the appended claims are expressed.

1. an ultraviolet detection system, comprising,
a Bluetooth MCU control unit, a Bluetooth antenna impedance matching unit, and an ultraviolet detection unit having an ultraviolet sensor, the Bluetooth antenna impedance matching unit including an IC matching circuit and a terminal matching circuit, the Bluetooth MCU control unit being used to do analog to digital (AD) testing, LED controlling, and antenna impedance matching;
wherein exposure of the ultraviolet detection unit being to light, an ultraviolet photoelectric diode, composed of a top silicon and located inside the ultraviolet detection unit, producing a current corresponding to radiation intensity of ultraviolet radiation of the light,
wherein current of an operational amplifier of the ultraviolet detection unit forms an output voltage corresponding to the current, the output voltage is transmitted to the Bluetooth MCU control unit, and the Bluetooth MCU control unit samples electrical signals, the Bluetooth MCU control unit is used to do AD sampling and testing, receiving and sending data signal, logic controlling, the Bluetooth antenna impedance matching unit is matched with the Bluetooth MCU control unit, and partly matched with an on board antenna of the Bluetooth antenna impedance matching unit, wherein the ultraviolet detection unit is a silicon product formed by an SOI technology, the SOI technology is a buried oxide layer being sandwiched between a top silicon layer and a substrate.

2. (canceled)

3. The ultraviolet detection system of claim 1, wherein the ultraviolet detection unit concerts intensities of an ultraviolet into an analog voltage, and outputs the analog voltage, the output analog voltage is converted to an ultraviolet intensity value according to a relationship among the inputting voltage, ADC voltage and ultraviolet irradiation (UVI), and the ultraviolet intensity value is shown on an application of a terminal device.

4. The ultraviolet detection system of claim 3, wherein a fifth terminal and an eighth terminal of the Bluetooth MCU control unit are connected with the ultraviolet detection unit, and used to test and integrate the ultraviolet intensity value.

5. The ultraviolet detection system of claim 4, wherein the ultraviolet detection unit further includes a chip, an OUT terminal of the chip is connected with a fifth terminal of the Bluetooth MCU control unit, an EN terminal of the chip is connected with the eighth terminal of the Bluetooth MCU control unit, a TR terminal of the chip is connected with a seventeenth capacitor and grounded, a GND terminal of the chip is grounded, a VDD terminal of the chip is connected with a power VCC, a fifteenth capacitor is connected between the GND terminal of the chip and the VDD terminal of the chip.

6. The ultraviolet detection system of claim 1, wherein a seventh terminal of the Bluetooth MCU control unit is connected with a resistor and a light emitting diode, the seventh terminal of the Bluetooth MCU unit controls the light emitting diode.

7. The ultraviolet detection system of claim 1, wherein a thirty first terminal of the Bluetooth MCU control unit and a thirty second terminal of the Bluetooth MCU control unit are both connected with the Bluetooth antenna impedance matching unit.

8. The ultraviolet detection system of claim 7, wherein a circuit of the Bluetooth antenna impedance matching unit includes a first coil, a second coil, a third coil, a fourth coil, a third capacitor, a fourth capacitor, a fifth capacitor, a sixth capacitor, a fourteenth capacitor, a sixteenth capacitor, and an antenna; the antenna, the sixteenth capacitor, the fourteenth capacitor, the fifth capacitor, the first coil, the second coil, the third capacitor are cascaded with each other in sequence, and then grounded, a lead between the first coil and the fifth capacitor is connected with the thirty second terminal of the Bluetooth MCU control unit, another lead between the first coil and the second coil is connected with the thirty first terminal of the Bluetooth MCU control unit, a lead between the second coil and the third capacitor is connected with a thirtieth terminal of the Bluetooth MCU control unit, the fourth capacitor is connected between the fifth capacitor and the fourteenth capacitor, and then grounded, the fourth capacitor is located between the fifth capacitor and the fourteenth capacitor, the fourteenth capacitor and the sixteenth capacitor are connected with the sixth capacitor and the second coil in parallel, and then grounded, the fourth coil is connected with the sixteenth capacitor and the antenna, and then grounded, the fourth coil is located between the sixteenth capacitor and the antenna.

9. The ultraviolet detection system of claim 1, wherein the Bluetooth MCU control unit is a chip which has forty eight foot, a first terminal of the chip is connected with a power VCC, and the first terminal of the chip is grounded through a twelfth capacitor; a ninth terminal of the chip is connected with a switch; a twelfth terminal of the chip is connected with the power VCC, and the twelfth terminal of the chip is grounded through an eleventh capacitor; a thirteenth terminal of the chip is grounded; a twenty fourth terminal is grounded by a first resistor, a twenty third terminal is connected with a D point, the twenty fourth terminal is connected with a C point, a G point is grounded, and the D point, the C point and the G point are programming points of the Bluetooth MCU control unit; a twenty ninth terminal is grounded through a tenth capacitor, a thirty third terminal and a thirty fourth terminal are both grounded, a thirty fifth terminal and a thirty sixth terminal are both connected with the power VCC, the thirty fifth terminal and the thirty sixth terminal are grounded through a ninth capacitor, a thirty seventh terminal is grounded through a first capacitor, a thirty eighth terminal is grounded through the second capacitor, a crystal oscillator is located between the thirty seventh terminal and the thirty eighth terminal, and the crystal oscillator is connected with the thirty seventh terminal and the thirty eighth terminal, a thirty ninth terminal is grounded through a eighth capacitor.

10. A method of detecting ultraviolet based on an ultraviolet detection system comprising a Bluetooth MCU control unit and a sensor, the method comprising:
an application installed in a terminal device having a terminal Bluetooth;
the Bluetooth MCU control unit transmitting a broadcast;
the terminal device recognizing the broadcast after the terminal Bluetooth matching with the Bluetooth MCU control unit;
the ultraviolet detection system exposed within a light together with the sensor facing the light;
the sensor concerting intensities of ultraviolet light into electrical signals;
the Bluetooth MCU control unit receiving the electrical signals transmitted by the sensor; and
the Bluetooth MCU control unit calculating an ultraviolet intensity value in light of the electrical signals and transmitting the ultraviolet intensity value to the terminal device to display to the user, wherein the ultraviolet detection system comprises a Bluetooth antenna impedance matching unit and an ultraviolet detection unit, the Bluetooth antenna impedance matching unit is matched with the Bluetooth MCU control unit, and partly matched with an on board antenna of the Bluetooth antenna impedance matching unit, wherein the ultraviolet detection unit is defined as a silicon product formed by a SOI technology, the SOI technology refers to a buried oxide layer being sandwiched between a top silicon and a substrate.

11-12. (canceled)

13. The method of detecting ultraviolet of claim 10, wherein the ultraviolet detection unit concerts intensities of an ultraviolet according to the SOI technology, and transforms an ultraviolet intensity into an analog voltage, and outputs the analog voltage, the output analog voltage is converted to an ultraviolet intensity value according to a relationship among the inputting voltage.

14. The method of detecting ultraviolet of claim 13, wherein a fifth terminal and an eighth terminal of the Bluetooth MCU control unit are connected with the ultraviolet detection unit, and used to test and integrate the ultraviolet intensity value.

15. The method of detecting ultraviolet of claim 14, wherein the ultraviolet detection unit further includes a chip, an OUT terminal of the chip is connected with a fifth terminal of the Bluetooth MCU control unit, an EN terminal of the chip is connected with the eighth terminal of the Bluetooth MCU control unit, a TR terminal of the chip is connected with a seventeenth capacitor and grounded, a GND terminal of the chip is grounded, a VDD terminal of the chip is connected with a power VCC, a fifteenth capacitor is connected between the GND terminal of the chip and the VDD terminal of the chip.

16. The method of detecting ultraviolet of claim 10, wherein a seventh terminal of the Bluetooth MCU control unit is connected with a resistor and a light emitting diode, the seventh terminal of the Bluetooth MCU control unit controls the light emitting diode.

17. The method of detecting ultraviolet of claim 10, wherein a thirty first terminal of the Bluetooth MCU control unit and a thirty second terminal of the Bluetooth MCU control unit are both connected with the Bluetooth antenna impedance matching unit.

18. The method of detecting ultraviolet of claim 17, wherein a circuit of the Bluetooth antenna impedance matching unit includes a first coil, a second coil, a third coil, a fourth coil, a third capacitor, a fourth capacitor, a fifth capacitor, a sixth capacitor, a fourteenth capacitor, a sixteenth capacitor, and an antenna; the antenna, the sixteenth capacitor, the fourteenth capacitor, the fifth capacitor, the first coil, the second coil, the third capacitor are cascaded with each other in sequence, and then grounded, a lead between the first coil and the fifth capacitor is connected with the thirty second terminal of the Bluetooth MCU control unit, another lead between the first coil and the second coil is connected with the thirty first terminal of the Bluetooth MCU control unit, a lead between the second coil and the third capacitor is connected with a thirtieth terminal of the Bluetooth MCU control unit, the fourth capacitor is connected between the fifth capacitor and the fourteenth capacitor, and then grounded, the fourth capacitor is located between the fifth capacitor and the fourteenth capacitor, the fourteenth capacitor and the sixteenth capacitor are connected with the sixth capacitor and the second coil in parallel, and then grounded, the fourth coil is connected with the sixteenth capacitor and the antenna, and then grounded, the fourth coil is located between the sixteenth capacitor and the antenna.

19. The method of detecting ultraviolet of claim 10, wherein the Bluetooth MCU control unit is a chip which has forty eight foot, a first terminal of the chip is connected with a power VCC, and the first terminal of the chip is grounded through a twelfth capacitor; a ninth terminal of the chip is connected with a switch; a twelfth terminal of the chip is connected with the power VCC, and the twelfth terminal of the chip is grounded through an eleventh capacitor; a thirteenth terminal of the chip is grounded; a twenty fourth terminal is grounded by a first resistor, a twenty third terminal is connected with a D point, the twenty fourth terminal is connected with a C point, a G point is grounded, and the D point, the C point and the G point are programming points of the Bluetooth MCU control unit; a twenty ninth terminal is grounded through a tenth capacitor, a thirty third terminal and a thirty fourth terminal are both grounded, a thirty fifth terminal and a thirty sixth terminal are both connected with the power VCC, the thirty fifth terminal and the thirty sixth terminal are grounded through a ninth capacitor, a thirty seventh terminal is grounded through a first capacitor, a thirty eighth terminal is grounded through the second capacitor.

20. The method of detecting ultraviolet of claim 19, wherein a crystal oscillator is located between the thirty seventh terminal and the thirty eighth terminal, and the crystal oscillator is connected with the thirty seventh terminal and the thirty eighth terminal, a thirty ninth terminal is grounded through a eighth capacitor.
